(19) United States
(12) Patent Application Publication
(10) Pub. No.: US 2008/0297458 A1
(43) Pub. Date: Dec. 4, 2008

(54) Liquid crystal display using combination dot inversion driving method and driving method thereof

(75) Inventor: Shun-Ming Huang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/156,568

(22) Filed: Jun. 2, 2008

(30) Foreign Application Priority Data
Jun. 1, 2007 (CN) 200710074807.X

(51) Int. Cl. G09G 3/36

(52) U.S. Cl. 345/96

(57) ABSTRACT

An exemplary liquid crystal display includes a data circuit, a memory, and a timing controller. The timing controller includes: a data analysis circuit configured for analyzing video signals stored in the memory and generating a corresponding control signal; and a polarity generating circuit configured for receiving the control signal and outputting a selected one of a first polarity control signal and a second polarity control signal to the data circuit according to the control signal. A related method for driving the liquid crystal display is also provided.

### FIELD OF THE INVENTION

The present invention relates to liquid crystal displays (LCDs) and methods for driving LCDs, and particularly to an LCD capable of using a combination dot inversion driving method.

### GENERAL BACKGROUND

An LCD utilizes liquid crystal molecules to control light transmissivity of each of pixel unit regions thereof. The liquid crystal molecules are driven according to external video signals received by the LCD. A conventional LCD generally employs a selected one of a frame inversion driving method, a line inversion driving method, a 1-line dot inversion driving method, and a 2-line dot inversion driving method to drive the liquid crystal molecules. Each of these driving methods can protect the liquid crystal molecules from decay or damage.

FIG. 5 is essentially an abbreviated circuit diagram of a conventional LCD. The LCD 100 includes a liquid crystal panel 10, a timing controller 101, a scanning circuit 102, a data circuit 103, and a common voltage generating circuit (not shown). The scanning circuit 102, the data circuit 103, and the common voltage generating circuit are configured for driving the liquid crystal panel 10.

The liquid crystal panel 10 includes a plurality of parallel scanning lines G1˜Gn, a plurality of parallel data lines D1˜Dm orthogonal to the scanning lines G1˜Gn, and a plurality of pixel units 130 cooperatively defined by the crossing scanning lines G1˜Gn and data lines D1˜Dm. The scanning lines G1˜Gn are electrically coupled to the scanning circuit 102, and the data lines D1˜Dm are electrically coupled to the data circuit 103.

Each pixel unit 130 includes a thin film transistor Qab (where a and b are natural numbers, 1≦a≦n, 1≦b≦n) and a liquid crystal capacitor Ccd (where c and d are natural numbers, 1≦c≦n,1≦d≦m). The thin film transistor Qab is disposed near an intersection of a corresponding one of the scanning lines G1˜Gn and a corresponding one of the data lines D1˜Dm. A gate electrode of the thin film transistor Qab is electrically coupled to the corresponding one of the scanning lines G1˜Gn, and a source electrode of the thin film transistor Qab is electrically coupled to the corresponding one of the data lines D1˜Dm. Further, a drain electrode of the thin film transistor Qab is electrically coupled to the liquid crystal capacitor Ccd.

The scanning circuit 102 outputs a plurality of scanning signals to scan the plurality of scanning lines G1˜Gn successively. For example, when the scanning line G1 is scanned, the thin film transistors Q11˜Q1m are turned on simultaneously. Then the data circuit 103 outputs data signals to the liquid crystal capacitors C11˜C1m via the data lines D1˜Dm and corresponding thin film transistors Q11˜Q1m. The common voltage generating circuit outputs common voltages to the liquid crystal capacitors C11˜C1m. After all the scanning lines G1˜Gn have been scanned in a single frame period, the aggregation of light transmitting through the respective pixel units 130 constitutes the display of an image on the liquid crystal panel 10.

The data signals applied to each liquid crystal capacitor Ccd include positive polarity data signals (+) and negative polarity data signals (−). A value of each positive polarity data signal is greater than that of the common voltage, and a value of each negative polarity data signal is less than that of the common voltage. When an absolute value of a difference between the positive polarity data signal and the common voltage of any one pixel unit 130 is equal to an absolute value of a difference between the negative polarity data signal and the common voltage of any other pixel unit 130, the two pixel units 130 display picture elements having a same gray level.

FIG. 6 is a diagram illustrating a principle of the 1-line dot inversion driving method. In order to simplify the following explanation, FIG. 6 only shows a 4-by-4 sub-matrix of pixel units 130 of the liquid crystal panel 10. The other pixel units 130 of the liquid crystal panel 10 have a polarity arrangement similar to that shown in FIG. 6. The polarity of each pixel unit 130 in FIG. 6 is opposite to the polarity of every directly adjacent pixel unit 130, and the polarity of each pixel unit 130 is reversed once in every frame period. When a 1-line dot inversion test pattern as shown in FIG. 7 is applied to the liquid crystal panel 10, the pixel units 130 arranged along oblique lines in the sub-matrix are in dark states, and the other pixel units 130 in the sub-matrix are in bright states. Referring to FIG. 8, this illustrates an operation principle of displaying the 1-line dot inversion test pattern of FIG. 7 on the LCD 100 using the 1-line dot inversion driving method. As shown in FIG. 8, the pixel units 130 marked with circles all have positive polarities during an (n−1)^{th} frame period, negative polarities during an n^{th} frame period, and positive polarities again during an (n+1)^{th} frame period. Because the common voltage of the liquid crystal panel 10 may shift slightly when the polarity of each pixel unit 130 is changed, the pixel units 130 displaying the same gray level but having opposite polarities may have different charging conditions. Accordingly, when the polarities of all the pixel units 130 in bright states displaying a same gray level are inverted at the same time, the corresponding image viewed by a user may flicker.

To overcome the above-described problems, a 2-line dot inversion driving method has been developed. FIG. 9 is a diagram illustrating a principle of the 2-line dot inversion driving method. In order to simplify the following explanation, FIG. 9 only shows a 4-by-4 sub-matrix of pixel units 130 of the liquid crystal panel 10. The other pixel units 130 of the liquid crystal panel 10 have a polarity arrangement similar to that shown in FIG. 9. The polarities of the pixel units 130 in the first and second rows are the same. The polarities of the pixel units 130 in the third and fourth rows are the same. The polarities of the pixel units 130 in the second row are opposite to the polarities of the pixel units 130 in the third row, and the polarities of the pixel units 130 in each column are opposite to the polarities of the pixel units 130 in each of the two adjacent columns. Moreover, the polarity of each pixel unit 130 is reversed once in every frame period.

FIG. 10 is a diagram illustrating an operation principle of displaying the 1-line dot inversion test pattern of FIG. 7 on the LCD 100 using the 2-line dot inversion driving method. When the 1-line dot inversion test pattern is applied to the liquid crystal panel 10 using the 2-line dot inversion driving method, only the pixel units 130 marked with circles are in bright states. Each pixel unit 130 in the bright state has a positive polarity during an (n−1)^{th} frame period, a negative polarity during an n^{th} frame period, a positive polarity again during an (n+1)^{th} frame period, and so on. This can balance the brightness differences between respective pixel units 130 in the bright state. Thus, the flicker problem associated with the 1-line dot inversion test pattern caused by the common voltage shift may be insignificant and not noticed by the human eye when the 2-line dot inversion driving method is used.

However, when the liquid crystal panel 10 uses the conventional 2-line dot inversion driving method to display a 2-line dot inversion test pattern as shown in FIG. 11, flicker may be observed by a user. As shown in FIG. 12, the pixel units 130 marked with circles all have positive polarities during an (n−1)th frame period, negative polarities during an n^{th} frame period, and positive polarities again during an (n+1)^{th} frame period. The pixel units 130 displaying the same gray level but having opposite polarities may have different charging conditions because the common voltage of the liquid crystal panel 10 may shift slightly when the polarity of each pixel unit 130 is changed. Accordingly, when the polarities of all the pixel units 130 in bright states displaying a same gray level are inverted at the same time the corresponding image viewed by a user may flicker.

In summary, flicker may be observed when the liquid crystal panel 10 displays special test patterns, no matter whether the 1-line dot inversion driving method or the 2-line dot inversion driving method is used.

What is needed, therefore, is an LCD and a driving method for the LCD which can overcome the above-described deficiencies.

### SUMMARY

A liquid crystal display includes a data circuit, a memory, and a timing controller. The timing controller includes: a data analysis circuit configured for analyzing video signals stored in the memory and generating a corresponding control signal; and a polarity generating circuit configured for receiving the control signal and outputting a selected one of a first polarity control signal and a second polarity control signal to the data circuit according to the control signal.

A driving method for a liquid crystal display includes: providing a liquid crystal display comprising a data circuit, a memory, and a timing controller, the timing controller comprising a data analysis circuit and a polarity generating circuit; receiving external video signals and writing the video signals to the memory by the timing controller; reading the video signals from the memory by the data analysis circuit; analyzing the video signals and generating a corresponding control signal by the data analysis circuit; and receiving the control signal and outputting a selected one of a first polarity control signal and a second polarity control signal to the data circuit according to the control signal by the polarity generating circuit.

Other novel features and advantages will become more apparent from the following detailed description when taken in conjunction with the accompanying drawings.

### BRIEF DESCRIPTION OF THE DRAWINGS

FIG. 1 is essentially an abbreviated circuit diagram of an LCD according to a first exemplary embodiment of the present invention, the LCD including a liquid crystal panel and a data circuit.

FIG. 2 is an abbreviated, combination diagram showing 1-line dot inversion test patterns and 2-line dot inversion test patterns.

FIG. 3 is a diagram illustrating an operation principle of displaying the combination of test patterns of FIG. 2 on the LCD of FIG. 1, when using a combination dot inversion driving method of a second exemplary embodiment of the present invention.

FIG. 4 is a flow chart summarizing the combination dot inversion driving method of the second exemplary embodiment of the present invention.

FIG. 5 is essentially an abbreviated circuit diagram of a conventional LCD.

FIG. 6 is a diagram illustrating a principle of a conventional 1-line dot inversion driving method.

FIG. 7 is a diagram of a conventional 1-line dot inversion test pattern.

FIG. 8 is a diagram illustrating an operation principle of displaying the 1-line dot inversion test pattern of FIG. 7 on the LCD of FIG. 5, when using the conventional 1-line dot inversion driving method.

FIG. 9 is a diagram illustrating a principle of a conventional 2-line dot inversion driving method.

FIG. 10 is a diagram illustrating an operation principle of displaying the 1-line dot inversion test pattern of FIG. 7 on the LCD of FIG. 5, when using the conventional 2-line dot inversion driving method.

FIG. 11 is a diagram of a conventional 2-line dot inversion test pattern.

FIG. 12 is a diagram illustrating an operation principle of displaying the 2-line dot inversion test pattern of FIG. 11 on the LCD of FIG. 5, when using the conventional 2-line dot inversion driving method.

### DETAILED DESCRIPTION OF PREFERRED EMBODIMENTS

Reference will now be made to the drawings to describe the preferred and exemplary embodiments in detail.

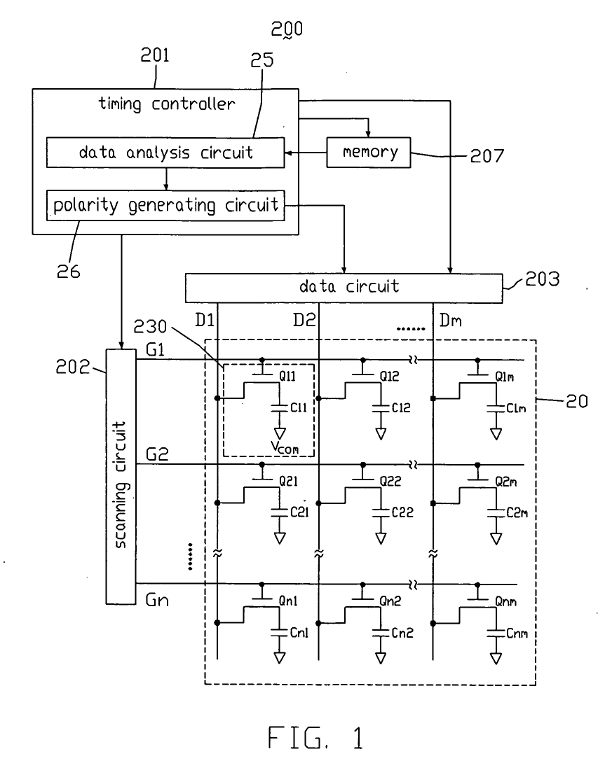

FIG. 1 is essentially an abbreviated circuit diagram of an LCD according to an exemplary embodiment of the present invention. The LCD 200 includes a liquid crystal panel 20, a timing controller 201, a scanning circuit 202, a data circuit 203, a memory 207, and a common voltage generating circuit (not shown). The scanning circuit 202, the data circuit 203, and the common voltage generating circuit are configured for driving the liquid crystal panel 20.

The liquid crystal panel 20 includes a plurality of parallel scanning lines G1˜Gn, a plurality of parallel data lines D1˜Dm orthogonal to the scanning lines G1˜Gn, and a plurality of pixel units 230 cooperatively defined by the crossing scanning lines G1˜Gn and data lines D1˜Dm. The scanning lines G1˜Gn are electrically coupled to the scanning circuit 202, and the data lines D1˜Dm are electrically coupled to the data circuit 203. The pixel units 230 are arranged in a regular matrix.

Each pixel unit 230 includes a thin film transistor Qab (where a and b are natural numbers, 1≦a≦n, 1≦b≦m) and a liquid crystal capacitor Ccd (where c and d are natural numbers, 1≦c≦n, 1≦d≦m). The thin film transistor Qab is disposed near an intersection of a corresponding one of the scanning lines G1˜Gn and a corresponding one of the data lines D1˜Dm. A gate electrode of the thin film transistor Qab is electrically coupled to the corresponding one of the scanning lines G1˜Gn, and a source electrode of the thin film transistor Qab is electrically coupled to the corresponding one of the data lines D1˜Dm. Further, a drain electrode of the thin film transistor Qab is electrically coupled to the liquid crystal capacitor Ccd.

The timing controller 201 receives external video signals and writes the video signals into the memory 207. The scanning circuit 202 outputs a plurality of scanning signals to scan the plurality of scanning lines G1˜Gn successively. For example, when the scanning line G1 is scanned, the thin film transistors Q11˜Q1m are turned on simultaneously. Then the data circuit 203 outputs data signals to the liquid crystal capacitors C11˜C1m via the data lines D1˜Dm and corresponding thin film transistors Q11˜Q1m. The common voltage generating circuit outputs common voltages to the liquid crystal capacitors C11˜C1m. After all the scanning lines G1˜Gn have been scanned in a single frame period, the aggregation of light transmitting through the respective pixel units 230 constitutes the display of an image on the liquid crystal panel 20.

The timing controller 201 includes a data analysis circuit 25 and a polarity generating circuit 26. The data analysis circuit 25 analyzes the video signals stored in the memory 207, and generates a first control signal or a second control signal. The polarity generating circuit 26 receives the first control signal or the second control signal, and outputs a first polarity control signal or a second polarity control signal to the data circuit 203. The data circuit 203 employs a combination of a 1-line dot inversion driving method and a 2-line dot inversion driving method, correspondingly.

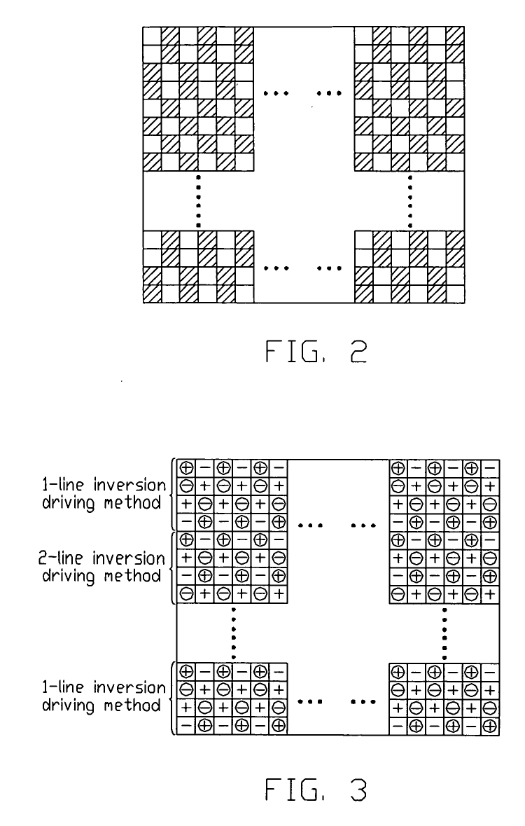

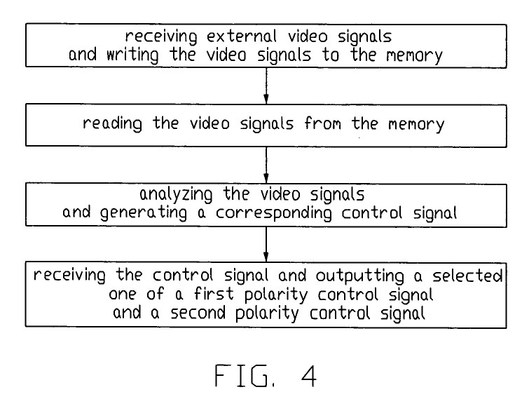

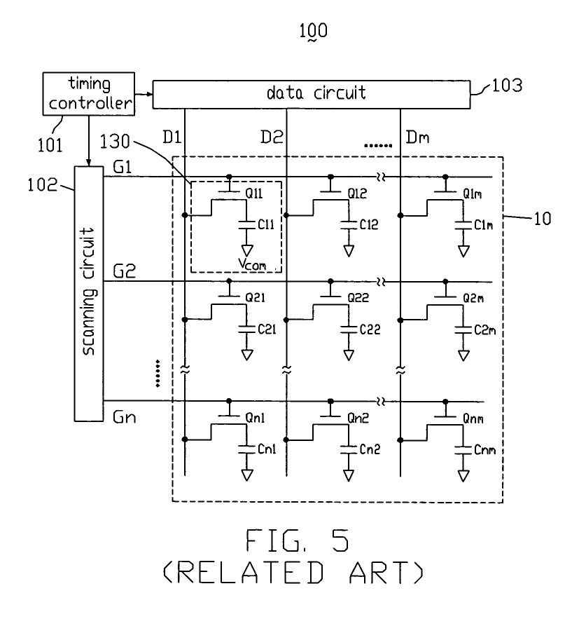

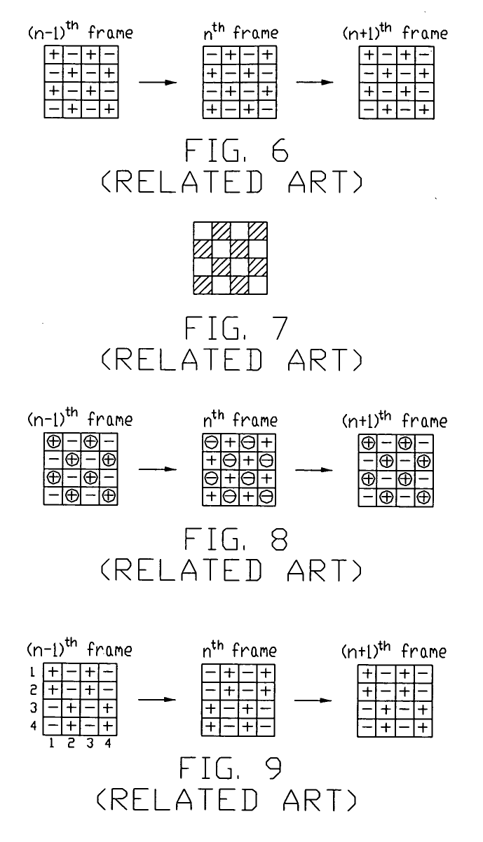

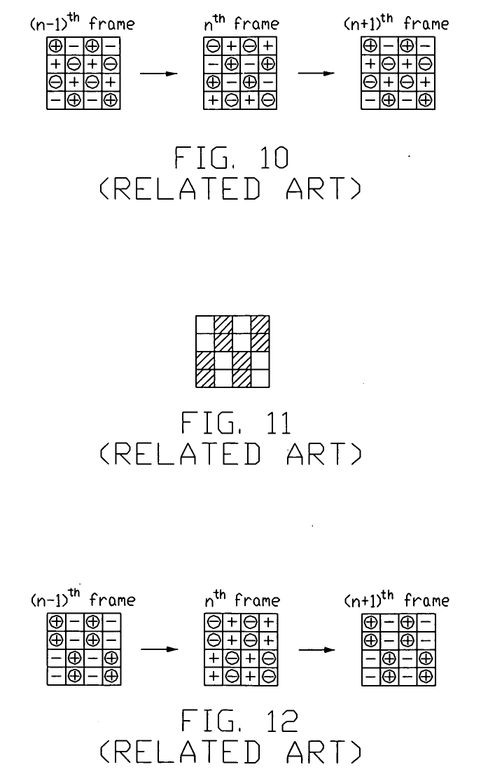

Refer to FIG. 3, the pixel units marked with circles represent displaying picture elements in bright states, and the other pixel units represent displaying picture elements in dark states. The bright states and the dark states are defined relative to each other. For example, when the data signal applied to each of the pixel units 230 is greater than or equal to 127 gray levels, the picture element displayed by the pixel unit 230 is defined as being in the bright state. When the data signal applied to each of the pixel units 230 is less than 127 gray levels, the picture element displayed by the pixel unit 230 is defined as being in the dark state.

The video signals stored in the memory 207 include a plurality of data, and each item of data corresponds to one picture element displayed by one of the plurality of pixel units 230. The plurality of data can be classified into bright data and dark data. The bright data are configured to make the pixel units 230 display picture elements in bright states, and the dark data are configured to make the pixel units 230 display picture elements in dark states. The plurality of data can also be classified into even data and odd data. The even data are configured to be applied to the pixel units 230 located at crossings of odd rows and odd columns of the pixel units 230, or at crossings of even rows and even columns of the pixel units 230. The odd data are configured to be applied to the pixel units 230 located at crossings of odd rows and even columns of the pixel units 230, or at crossings of even rows and odd columns of the pixel units 230.

An exemplary combination dot inversion driving method for the LCD 200 when used to display the combination test patterns of FIG. 2 is as follows:

Firstly, the timing controller 201 receives external video signals corresponding to the combination test patterns of FIG. 2. Then the video signals are written into the memory 207. The data analysis circuit 25 reads the video signals from the memory 207 and analyzes the video signals. When the number of data items belonging to both the bright data and the even data is equal to the number of data items belonging to both the bright data and the odd data in any part of the video signals (e.g. the part of the video signals corresponding to at least four continuous rows of pixel units 230), the data analysis circuit 25 generates a first control signal. The polarity generating circuit 26 receives the first control signal, and outputs the first polarity control signal to the data circuit 203. The data circuit 203 employs the 1-line dot inversion driving method, correspondingly. When the number of data items belonging to both the bright data and the even data is not equal to the number of data items belonging to both the bright data and the odd data in any part of the video signals (e.g. the part of the video signals corresponding to at least four continuous rows of pixel units 230), the data analysis circuit 25 generates a second control signal. The polarity generating circuit 26 receives the second control signal, and outputs the second polarity control signal to the data circuit 203. The data circuit 203 employs the 2-line dot inversion driving method, correspondingly.

When the LCD 200 uses the combination dot inversion driving method, the LCD 200 chooses to employ the 1-line dot inversion driving method or the 2-line dot inversion driving method according to particular brightness characteristics of the received video signals and the particular locations in the matrix of pixel units 230 that the video signals correspond to. The number of data items belonging to both the bright data and the even data is equal to the number of data items belonging to both the bright data and the odd data in any part of the video signals at any time. This can balance the brightness differences between respective pixel units 230 in the bright state. Thus, any flicker problem caused by a common voltage shift may be insignificant and not noticed by the human eye when the combination dot inversion driving method is used.

It is to be further understood that even though numerous characteristics and advantages of the present embodiments have been set out in the foregoing description, together with details of the structures and functions of the embodiments, the disclosure is illustrative only; and that changes may be made in detail, especially in matters of shape, size, and arrangement of parts within the principles of the invention to the full extent indicated by the broad general meaning of the terms in which the appended claims are expressed.

What is claimed is:

1. A liquid crystal display, comprising:
a data circuit;
a memory; and
a timing controller comprising:
a data analysis circuit configured for analyzing video signals stored in the memory and generating a corresponding control signal; and
a polarity generating circuit configured for receiving the control signal and outputting a selected one of a first polarity control signal and a second polarity control signal to the data circuit according to the control signal.

2. The liquid crystal display of claim 1, wherein the first polarity control signal is used to control the data circuit to employ a first inversion driving method, and the second polarity control signal is used to control the data circuit to employ a second inversion driving method.

3. The liquid crystal display of claim 2, wherein the first inversion driving method is a 1-line dot inversion driving method, and the second inversion driving method is a 2-line dot inversion driving method.

4. The liquid crystal display of claim 1, further comprising a liquid crystal panel, wherein the liquid crystal panel comprises a plurality of pixel units arrayed in a matrix.

5. The liquid crystal display of claim 4, wherein the video signals stored in the memory include a plurality of data, each item of data corresponds to a picture element displayed by one of the plurality of pixel units, the plurality of data are classified into bright data configured to make the pixel units display picture elements in bright states and dark data configured to make the pixel units display picture elements in dark states, the plurality of data are also classified into even data configured to be applied to the pixel units at crossings of odd rows and odd columns of the pixel units or at crossings of even rows and even columns of the pixel units, and odd data configured to be applied to the pixel units at crossings of odd rows and even columns of the pixel units or at crossings of even rows and odd columns of the pixel units.

6. The liquid crystal display of claim 5, wherein the data analysis circuit generates a first control signal when the number of data items belonging to both the bright data and the even data is equal to the number of data items belonging to both the bright data and the odd data in any predetermined part of the video signals, and generates a second control signal when the number of data items belonging to both the bright data and the even data is not equal to the number of data items belonging to both the bright data and the odd data in said any predetermined part of the video signals.

7. The liquid crystal display of claim 6, wherein the polarity generating circuit outputs the first polarity control signal to the data circuit when the first control signal is inputted to the polarity generating circuit, and outputs the second polarity control signal to the data circuit when the second control signal is inputted to the polarity generating circuit.

8. The liquid crystal display of claim 7, wherein said any predetermined part of the video signals corresponds to at least four continuous rows of the pixel units.

9. A driving method for a liquid crystal display, the method comprising: providing a liquid crystal display comprising a data circuit, a memory, and a timing controller, the timing controller comprising a data analysis circuit and a polarity generating circuit;
receiving external video signals and writing the video signals to the memory by the timing controller;
reading the video signals from the memory by the data analysis circuit;
analyzing the video signals and generating a corresponding control signal by the data analysis circuit; and
receiving the control signal and outputting a selected one of a first polarity control signal and a second polarity control signal to the data circuit according to the control signal by the polarity generating circuit.

10. The driving method of claim 9, wherein the first polarity control signal is used to control the data circuit to employ a first inversion driving method, and the second polarity control signal is used to control the data circuit to employ a second inversion driving method.

11. The driving method of claim 10, wherein the first inversion driving method is a 1-line dot inversion driving method, and the second inversion driving method is a 2-line dot inversion driving method.

12. The driving method of claim 9, wherein the liquid crystal display further comprises a liquid crystal panel, and the liquid crystal panel comprises a plurality of pixel units arranged in a matrix.

13. The driving method of claim 12, wherein the video signals stored in the memory include a plurality of data, and each item of data corresponds to a picture element displayed by one of the plurality of pixel units, the plurality of data are classified into bright data configured to make the pixel units display picture elements in bright states and dark data configured to make the pixel units display picture elements in dark states, the plurality of data are also classified into even data configured to be applied to the pixel units at crossings of odd rows and odd columns of the pixel units or at crossings of even rows and even columns of the pixel units, and odd data configured to be applied to the pixel units at crossings of odd rows and even columns of the pixel units or at crossings of even rows and odd columns of the pixel units.

14. The driving method of claim 13, wherein the data analysis circuit generates a first control signal when the number of data items belonging to both the bright data and the even data is equal to the number of data items belonging to both the bright data and the odd data in any predetermined part of the video signals, and generates a second control signal when the number of data items belonging to both the bright data and the even data is not equal to the number of data items belonging to both the bright data and the odd data in said any predetermined part of the video signals.

15. The driving method of claim 14, wherein the polarity generating circuit outputs the first polarity control signal to the data circuit when the first control signal is inputted to the polarity generating circuit, and outputs the second polarity control signal to the data circuit when the second control signal is inputted to the polarity generating circuit.

16. The driving method of claim 15, wherein said any predetermined part of the video signals corresponds to at least four continuous rows of the pixel units.
